(19) United States
(12) Patent Application Publication
(10) Pub. No.: US 2007/0148542 A1
(43) Pub. Date: Jun. 28, 2007

(54) Battery electrode design and a flat stack battery cell design and methods of making same

(76) Inventors: Joseph Szymborski, Clermont, FL (US); Edward M. Mattan, Fort Smith, AR (US)

Correspondence Address: PATENT ADMINISTRATOR;KATTEN MUCHIN ROSENMAN LLP, 1025 THOMAS JEFFERSON STREET, N.W., EAST LOBBY: SUITE 700, WASHINGTON, DC, 20007-5201, US

(21) Appl. No.: 11/314,923

(22) Filed: Dec. 22, 2005

(51) Int. Cl. H01M 2/28; H01M 4/72; H01M 2/06; H01M 10/04

(52) U.S. Cl. 429/211; 429/241; 429/161; 429/181; 29/623.1

(57) ABSTRACT

A battery electrode design and a flat stack battery cell design preferably include structure and/or manufacturing steps whereby a battery electrode plate has a frame, and a grid-array of elements disposed interiorly of the frame. A first collector pole access channel is disposed interiorly of the frame and orthogonal with respect to the grid-array of elements, and a second collector pole access channel is also disposed interiorly of the frame and orthogonal with respect to the grid-array of elements. Preferably, the collector pole access channels are made by hole-punching lead slugs integrally disposed in the grid-array. Preferably, the electrode plates are a standard size, and may be disposed in a common jar; thus, the battery capacity is determined by the number of electrode plates in the jar, the jar being trimmed per the number of electrode plates.

### BACKGROUND OF THE INVENTION

1. Field of the Invention

The present invention relates to a novel battery electrode design and a flat stack battery cell design for use in storage batteries (such as industrial, valve regulated lead-acid electrical storage batteries), and methods for producing same.

2. Description of Related Art

Storage batteries are used in a wide variety of industrial applications such as automobiles, submarines, ships, trucks, airplanes, all types of vehicles, power back-up applications, renewable energy storage systems, uninterruptible power supplies, material handling equipment, personnel carriers, automated guided vehicles, etc. Furthermore, batteries are used in a wide variety of electrical capacities to suit the many uses for which they are applied. With batteries in such high demand, it is important to design batteries that are smaller, more efficient, longer lasting, and easy to produce in a variety of different electrical capacities.

Lead acid batteries are typically constructed using a plurality of positive and negative electrode plates alternately arranged and separated by a non-conducting, microporous separator material. These electrode plates typically comprise a grid that is cast or cold worked (expanded and/or punched), and an active material (typically a paste mixture of lead oxide, water, acid, and other components) that is applied to the grid. The grid can be made from pure lead or lead alloyed with other elements, such as calcium and tin, to provide strength, rigidity, conductivity, corrosion resistance, and gassing overpotential.

In the past, the grid has been designed to conform to the typical construction of a lead-acid battery. In particular, the grid usually comprises a frame that defines the outer perimeter of the structure, a central “screen-like” mesh onto which the active material is applied, and a top frame and plate lug. The top frame, as its name implies, is usually located along the top of the grid and is usually integral with the plate lug, which extends upward from the top frame. See, for example U.S. Pat. No. 5,264,306; and Des. 332,082.

The plate lug, which acts as the primary electrical current path to the battery terminal, is typically located along the top edge of the grid. In fact, because of the way a battery is typically constructed, the plate lug is usually located near one of the corners of the top frame. This means that the distance varies significantly from the plate lug to the various current-generation positions in the plate; thus the resistance from the lug to the various points on the plate varies, making utilization of the active material more difficult the further it is away from the plate lug. Various attempts have been made to reduce the overall resistance to any one point on the plate from the lug, including: adding radial conductors from the lug area into the plate; increasing the number of vertical wires in the grid design; and increasing the thickness of the vertical wire members. The resistance effects related to the location of the lug on the grid can limit the usefulness of additional active material and can limit the shape and size of the grid used in a lead-acid battery. Also, the plate lug configuration of known batteries requires an extension at the top of the battery case to accommodate the lugs of the numerous battery grids.

Typical industrial storage batteries are disclosed in, inter alia, U.S. Pat. Nos. 6,815,118; 6,667,130; 6,462,517; and 6,524,747; and in U.S. Patent Application Publications Nos. 2005/0100791; 2005/0066498; 2005/0058884; and 2005/0037264. However, none of these documents provides a solution to the problems noted above.

Thus, what is needed is an electrical storage battery, and method for constructing said storage battery, that optimally minimizes the current path from any one part of the electrode plate, and can be easily modified to suit a plurality of electrical storage capacities. Such a battery should also be easy to assemble and require a smaller physical footprint than known batteries.

### SUMMARY OF THE INVENTION

It is an advantage of the present invention to overcome the problems of the related art and to provide a battery electrode plate design that locates the current collection point at a location that is more central to the plate, and a lead-acid battery design that utilizes this unique construction. This will, in turn, reduce the resistance between the current collection point and any other point on the grid structure; and thus increase the effectiveness and utilization of the active material applied to the grid in these areas. The resulting battery will be easier to manufacture, require fewer individual components, allow easy expansion of the product line (by the use of standardized grids, jars, and covers), and provide improved battery performance resulting from a lower internal resistance.

According to a first aspect of the present invention, a novel combination of structure and/or steps is provided for a lead-acid battery having a first electrode plate comprising (i) a frame, (ii) a plurality of intersecting conducting members forming a grid disposed in the interior of said frame, (iii) first and second collector pole access channels disposed in the interior of said frame, (iv) a coating of a lead-acid battery active material paste. A second electrode plate comprises (i) a frame, (ii) a plurality of intersecting conducting members forming a grid disposed in the interior of said frame, (iii) first and second collector pole access channels disposed in the interior of said frame, (iv) a coating of a lead-acid battery active material paste. A first current collector pole is configured to be installed in the first collector pole access channel of the first electrode plate and the first collector pole access channel of the second electrode plate. A second current collector pole is configured to be installed in the second collector pole access channel of the first electrode plate and the second collector pole access channel of the second electrode plate.

According to a second aspect of the present invention, a novel combination of structure and/or steps is provided for a lead-acid storage battery electrode grid having a frame, and a plurality of intersecting members forming a grid disposed interiorly of the frame. At least two disc slugs are disposed in the interior of the frame, the slugs being configured to be hole-punched to accommodate current collector poles through the punched holes.

According to a third aspect of the present invention, a novel combination of structure and/or steps are provided for a storage battery electrode plate having a frame, and a grid of elements disposed interiorly of the frame. A first collector pole access channel is disposed interiorly of the frame and orthogonal with respect to the grid of elements, and a second collector pole access channel is also disposed interiorly of the frame and orthogonal with respect to the grid of elements.

According to a fourth aspect of the present invention, a novel combination of steps is provided for a method of constructing a lead-acid battery, comprising the steps of: (i) providing first and second current collector poles; (ii) providing first and second electrode plates, each electrode plates comprising (a) a frame, (b) a plurality of intersecting conducting members forming a grid disposed interiorly of the frame, (c) first and second disc slugs disposed interiorly of the frame, and (d) a coating of a lead-acid battery active material paste; (iii) hole-punching the first slug of the first electrode plate forming a collector pole access channel configured to interference-fit with said first current collector pole; (iv) hole-punching the second slug of the first electrode to form a collector pole access channel configured to be larger than the outside diameter of said second current collector pole; (v) installing the first electrode onto the current collector poles and welding the first electrode to the first current collector pole at the interference-fit with the first collector pole access channel; (vi) covering the second electrode plate with a mat separator; (vii) hole-punching the first slug of the second electrode plate and separator to form a collector pole access channel configured to be larger than the outside diameter of the first current collector pole; (viii) hole-punching the second slug of the second electrode plate and separator to form a collector pole access channel configured to interference-fit with the second current collector pole; and (ix) installing the second electrode onto the current collector poles and welding the second electrode to the second current collector pole at the interference-fit with the second collector pole access channel.

### BRIEF DESCRIPTION OF THE DRAWINGS

Exemplary embodiments of the presently preferred features of the present invention will now be described with reference to the accompanying drawings.

FIG. 1 is a schematic view of a single electrode grid showing the positions of the collector pole access channel punch-out slugs.

FIG. 2 is a schematic perspective view of positive and negative electrode plates showing the positions of interference and clearance collector pole access channels.

FIG. 3 is a schematic perspective view of positive and negative electrode plates being stacked, with cutaways to show the relative positions of the current collector poles, according to the present invention.

FIG. 4 is a schematic perspective view of positive and negative plates being stacked, with cutaways, showing where the plates are welded to their respective current collector poles.

FIG. 5 is a schematic perspective view of a completed stack being contained inside a plastic jar with the positive and negative current collector poles protruding out the top of the jar cover where they can be connected to their respective positive and negative terminal leads.

FIG. 6 is a schematic perspective view of a completed stack being contained inside a plastic jar with the positive and negative current collector posts protruding out the top of the jar cover and connected to their respective positive and negative terminal leads which extend to the side of the battery housing for easy access.

### DETAILED DESCRIPTION OF THE PRESENTLY PREFERRED EXEMPLARY EMBODIMENTS

1. Introduction

The present invention will now be described with respect to a Valve Regulated Lead-Acid (VRLA) battery having positive and negative plates, each comprising a rectangular matrix array of wire grids with an overlying active material paste. However, the present invention is applicable to any electrical storage battery cell having any type of positive and negative plates.

Briefly, the present invention proposes a battery electrode plate structure and method whereby each battery electrode grid includes two internally disposed collector pole access channels. Preferably, two lead slugs are formed interiorly of the electrode outer frame, preferably along a diagonal line, each slug being about ⅓ of the distance from opposite frame corners. During manufacturing, the slugs are punched out and collector poles are inserted into the holes of the stacked electrode plates (or the plates are stacked onto the poles). The negative collector pole, installed through one set of aligned collector pole access channels, is welded to odd electrode plates, and insulated from even electrode plates. The positive collector pole, inserted through the other set of aligned collector pole access channels, is likewise alternately welded to the even electrode plates and insulated from the odd electrode plates. This permits efficient current collection, rapid construction, and reduced footprint. Also, the grids, jars, and caps can be made in a standard size, merely increasing battery capacity by simply adding more grids and cutting the jar to the appropriate size.

An advantage of locating the collector poles in the interior of the electrode is that it minimizes current paths to the collector poles, thus reducing resistance, improving electrical performance, increasing battery life, and delivering more current. In more detail, for a single current collection point, the ideal location of the plate lug in a battery grid and plate would be at the center of the plate. This would reduce the distance between the current collection point and any other point on the grid to a minimum. This is impractical in most instances, because provisions must be made for both positive and negative current collectors on the grids and to minimize the ohmic losses between the current collection point and any other location on the grid. The present invention approximates this ideal by disposing both the positive and negative poles in the interior of the electrode grid structure.

2. Electrode Grid Structure

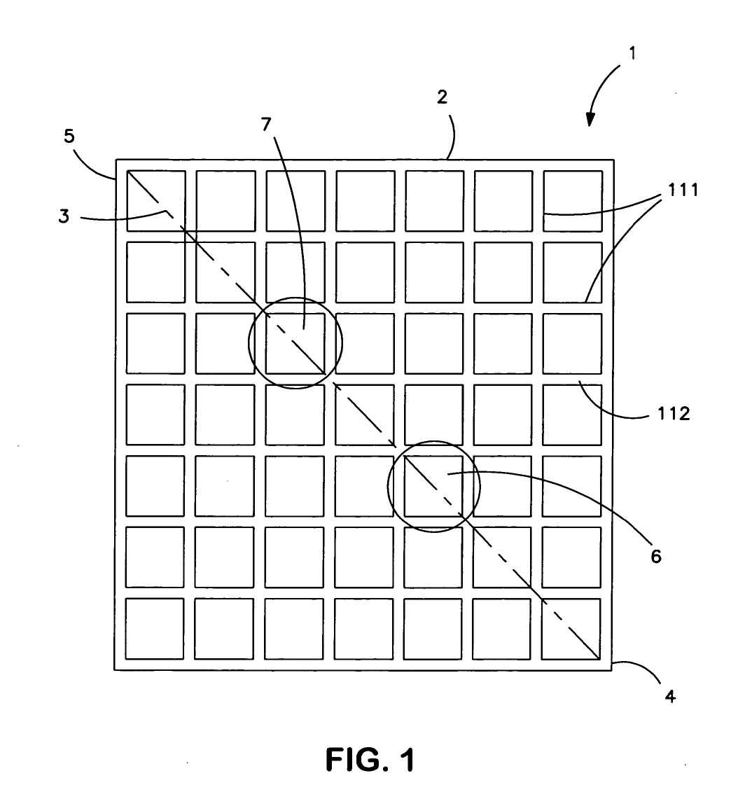

As seen in notional schematic of FIG. 1, the proposed grid 1 has a substantially square footprint; although a rectangular, trapezoidal, parallelepiped, curvilinear, or even a circular grid could be designed using this approach. The grid comprises an outer frame 2 around the perimeter of the structure to provide rigidity and to prevent skewing and distortion to the squareness of the grid. The frame could be designed strictly on the basis of strength without regard for electrical conductivity.

The interior of the grid comprises a mesh-type matrix array of elements 111. The pattern could be configured much like a “spider web” to provide strength, rigidity and minimal resistance. In the preferred embodiment of FIG. 1, the array comprises a rectangularly-oriented grid where each grid element is integrally formed as one piece with the frame. Each grid element substantially comprises a lead alloy which has a substantially five or six sided cross-section, although a square, circular, semicircular, rectangular, trapezoidal,. etc. cross-section may be used. Of course, the grid elements may be arrayed in a circularly-oriented array with radial connecting members, or any other convenient array of grid elements.

Preferably, the grid (both the frame and the interior mesh-type matrix) is cast as a single, integral entity. Therefore both the frame and the interior mesh are preferably made of the same composition of lead or alloy of lead. In the preferred embodiment, the lead alloy in the positive plate grid has a composition having 0.4-1.0% tin, 0.04-0.1% calcium, and 0.02% silver; however any lead alloy commonly used in the manufacture of lead-acid batteries could be used. In the preferred embodiment, the negative plate grid alloy has a composition of 0.06-0.1% calcium and 0.05% aluminum, although any lead alloy used in the manufacture of lead-acid batteries could be used. The proposed design is not dependent on the use of a particular grid alloy.

In the preferred embodiment, the grid frame can have an overall thickness of 0.100 to 0.250 inches (2.5 to 6 mm); the cross-section of the frame is typically 5 or 6 sided with tapered edges to make ejection from the grid casting mold easier Perfectly square and/or round cross-sections are difficult to cast; however straight edges are achievable in cold-worked or punched grids. The cross-section of the wires that make up the interior mesh matrix are typically “diamond” shaped with the peaks of the diamond directed vertically with the grid positioned on its frame—this is to assist in applying the paste onto the grid. In most cases the thickness of these internal wires is slightly less than the overall thickness of the grid as measured at its frame; this is to ensure that the interior grid mesh wires are completely encapsulated in the active material paste. In most cases the mesh grid itself is square or rectangular in shape, although circular, semi-circular and trapezoidal mesh configurations have been used in lead-acid battery grids.

In the preferred embodiment for this design, the grid measures 12×12 inches (300×300 mm), although the size may vary from about 6 inches square to about 18 inches square.

Along a diagonal line 3 drawn across opposite corners 4 and 5 of the grid and at about one third of the distance from the corners are two solid lead alloy slugs 6 and 7 preferably cast or formed as an integral part of the grid. The slugs could, however, be cast anywhere on the interior of the frame, as required. The slugs would optimally be the same thickness of the grid elements 111 and would typically be about 1-2 inches (2.5-5 cm) in diameter, but could be variety of thicknesses and diameters depending on specific requirements. One of the slugs 6 or 7 will eventually become the current collection point for the plate; the other slug 6 or 7 will become a clearance hole for the opposite polarity pole. Alternatively, the punch-out slugs may be eliminated by simply casting or forming the grid plate with appropriate collector pole access channels in the collector pole positions.

The size of each slug is determined by the overall size of the battery grid and the anticipated current that the plate will provide under discharge load conditions. Both the positive grid and the negative grid may use the same pattern, varying only in thickness by the amount of active material required for desired battery performance, or the grids may be made differently to specific requirements of either the negative or positive electrode. Of course, a variety of shapes and sizes could be adapted without departing from the scope and spirit of the present invention.

An active material paste 112 is deposited on one or more of the electrode grid elements 111 of one or more of the electrode plates 12 and 13. The electrode active material pastes are typically mixtures of lead oxide, water, sulfuric acid and additives (e.g., flock, expander, etc depending on whether applied to the positive or the negative grid), as is known in the art.

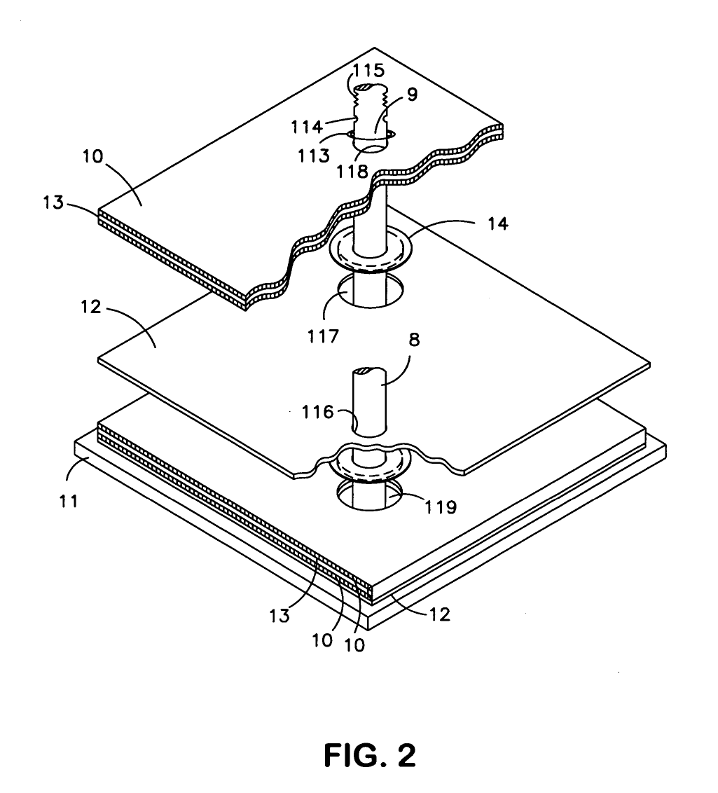

After the active material paste 112 has been applied to the grid 1, forming a plate 12 or 13, one of the grid slugs 6 or 7 is punched to provide an interference fit to a current collector pole 8 or 9 (FIG. 2). Each pole is shaped so as to have a circular, rectangular, hexagonal, or octagonal cross section (to assist in alignment). Eventually, each collector pole is welded to appropriate electrode plates using one or more welding processes to provide an electrical path to one of the battery's terminal posts. The second grid slug 7 is punched as a clearance hole so that the other current collector pole 8 or 9 of the opposite polarity could fit through the plate without contacting the plate or causing a short circuit. Of course, the holes punched through the slugs may be made the same or different sizes and/or the collector poles may be made the same or different sizes to accomplish the interference fit and the clearance fit, as desired. In another alternative, each collector pole may have one or more flanges 113, detents 114, ratchets 115, etc. to secure the respective electrode plates and/or separators to the collector poles, with or without welding, as shown in FIG. 2.

In the FIG. 2 embodiment, the electrode plates comprise substantially square plates 12 and 13 that are fabricated with slugs 6 and 7 located along the diagonal 3 drawn from the upper left hand corner 5 to the lower right hand corner 4 of each plate. However, the plates could have any shape with slugs located anywhere on the interior of the outer frame. One slug 6 on a first negative plate 12 is punched to provide an interference collector pole access channel 116 to a current collector pole 8. The upper left hand slug 7 of the plate 12 is punched to provide a clearance collector pole access channel 117 that will completely clear the other current collector pole 9. The positive plate 13, on the other hand, is punched to provide and interference-fit collector pole access channel 118 to a current collector pole 9 at the upper left hand slug 7, and is punched to provide a clearance-fit collector pole access channel 119 at the lower right hand slug 6 (not shown in FIG. 2) so that it completely clears the current collector pole 8. In this configuration, the current collector poles 8 and 9 would fit right through the stack of the negative plates 12 and the positive plates 13 combined, to provide the desired capacity for the battery.

One of the electrode plates (typically the positive plate) is wrapped with a microporous fiberglass mat separator 10 (like that used in typical Absorbed Glass Mat (AGM) VRLA battery designs) before being punched so that the plate slugs 6 and 7 and separator 10 are prepared simultaneously, providing perfect alignment of the collector pole access channels 118 or 119 and separator 10. Alternately, a microporous fiberglass separator can be prepared separately and simply placed between adjacent electrodes. The preceding example is a preferred embodiment of the present invention but could be modified in various ways without departing from the scope and spirit of the present invention.

3. Assembly of the Battery

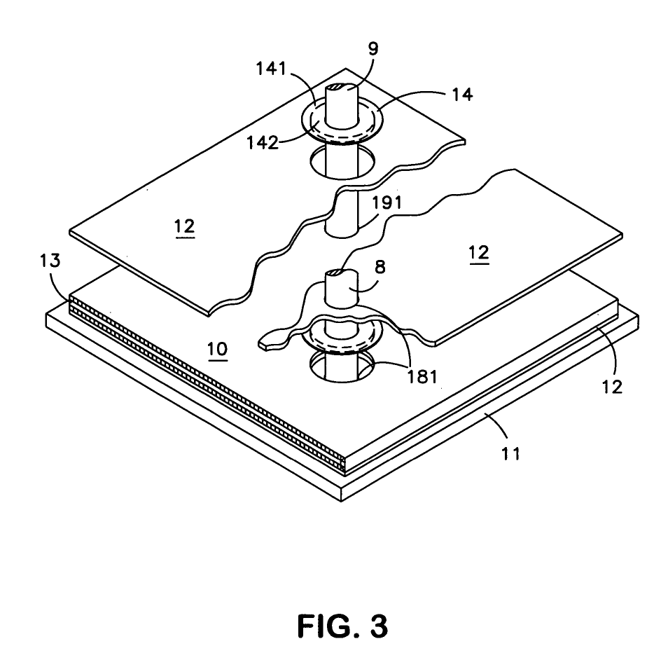

To assemble a battery cell using the plates as described above, a base plate 11 (as shown in FIG. 3), or some other device is used to position the negative current collector pole 8 and the positive current collector pole 9 in a fixed location. The current collector poles are preferably solid lead rods or lead rods with a copper insert (or other low resistance material). Of course, rectangular, hexagonal, or octagonal shapes may be used to provide improved conductivity and better contact with the channels in the electrode grids. An appropriately punched negative plate 12 is then positioned over the current collector poles interfering (or fitting closely) with the negative current collector pole 8 and clearing around the positive current collector pole 9. The negative plate 12 is then welded (or otherwise affixed) to the negative current collector pole 8 at weld 181 by one of the approaches described in more detail below.

Next, as shown in FIG. 3, the positive plate 13 (wrapped with the AGM separator material 10, if used, and punched as described previously) is positioned over the current collector poles interfering or fitting closely with the positive current collector pole 9 and clearing the negative current collector pole 8. As an additional precaution, an insulating separator disc 14 may be dropped over the current collector pole, negative 8 or positive 9 depending on which is being cleared, fitting between the collector pole 8 or 9 and the plate 12 or 13, to allow for growth of the positive plate as the battery ages, and to help prevent shorts. For example, the separator disc 14 may comprise a larger disc 141 coupled to or integral with a smaller disc 142. Preferably, as the positive plate 13 is lowered over the current collector poles 8 and 9, an appropriate force can be applied, either manually or by some automated process, to compress the plate 13 and separator section 10 to achieve the appropriate compression of the AGM separator 10 for optimum battery operation. While holding the plate under compression, the positive plate 13 is connected to the positive current collector post 9 at weld 191 to provide both an electrical connection and to fix the stack compression. The compression of the microporous fiberglass separator is for optimum performance of the battery, but is not a necessary component of the present invention. Preferably compression of 15-30% of the AGM separator thickness is applied before each weld.

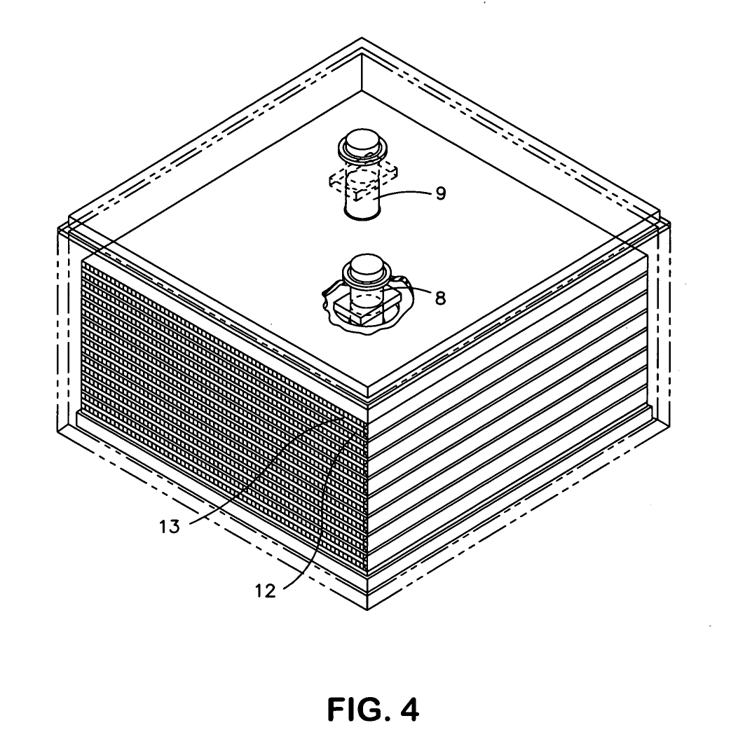

The assembly of the battery continues by alternating negative 12 and positive 13 plates, positioning them over the current collector poles 8 and 9, holding them under compression, and welding the respective plate to its respective current collector pole. The battery thus comprises alternately stacked negative 12 and positive 13 plates, each welded to a current collector pole 8 or 9 of its respective polarity and held under appropriate compression for optimum life and performance. The stacked assembly is completed using a final outside negative plate. As shown in FIG. 4, the number of plates stacked determines the capacity of the battery. For example, a stack of 5 positive plates (each 5 mm thick) and 6 negative plates (each 4 mm thick), and each measuring 12×12 inches will produce a 2-volt cell having a capacity of approximately 750 Ampere-hours. Batteries of varying capacities thus may be assembled and manufactured using a single plate type, incrementing the nominal capacity of the battery simply by adding plates.

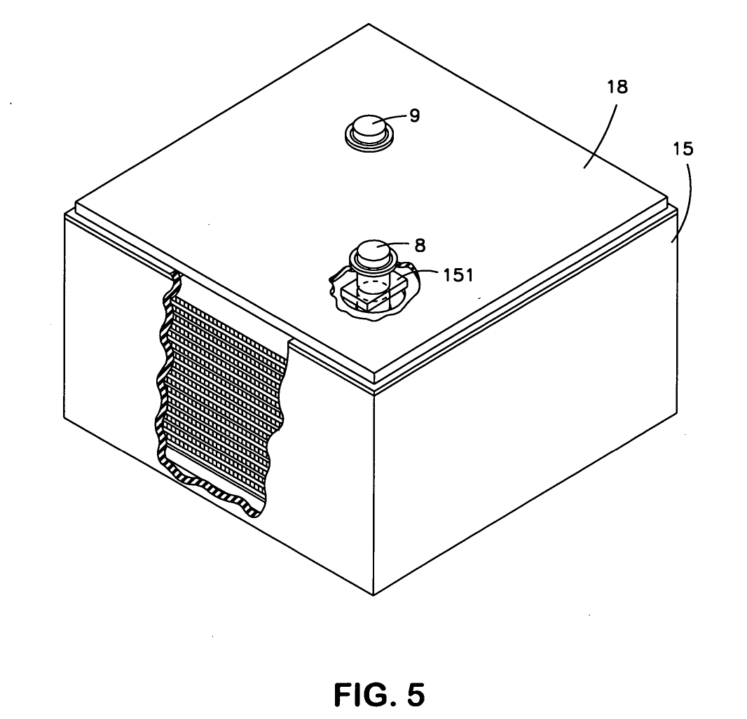

The plate assembly is then placed inside of a plastic jar 15, seen in FIG. 5. The jar 15 may be molded of any plastic suitable for use as a lead-acid battery container, such as polypropylene, a polypropylene-polyethylene copolymer, PVC, polycarbonate, styrene (ABS), etc. The dimensional tolerances of the jar can be somewhat relaxed compared to conventional VRLA AGM batteries that rely on the container to provide the necessary compression to the separator and cell stack. Various cell capacities may be accommodated using a single, standardized molded jar (e.g., 315 mm long, by 315 mm wide, by 250 mm high) whose height is cut or molded at the appropriate level to correspond to the height (and number of plates and ampere-hour capacity) of the desired stacked assembly. The two current collector poles 8 and 9 rise above the stacked assembly to a height somewhat above the height of the jar 15 so as to allow their connection to a cell cover 18. The current collector poles 8 and 9 are connected to the cell cover 18 through a lead bushing 151 molded into the cell cover 18. The connection between the current collector pole and the bushing can be made by a variety of methods used in the manufacture of lead acid batteries (welding, induction heating, etc.) In this configuration the cell's terminal posts are located on the top of the cell assembly.

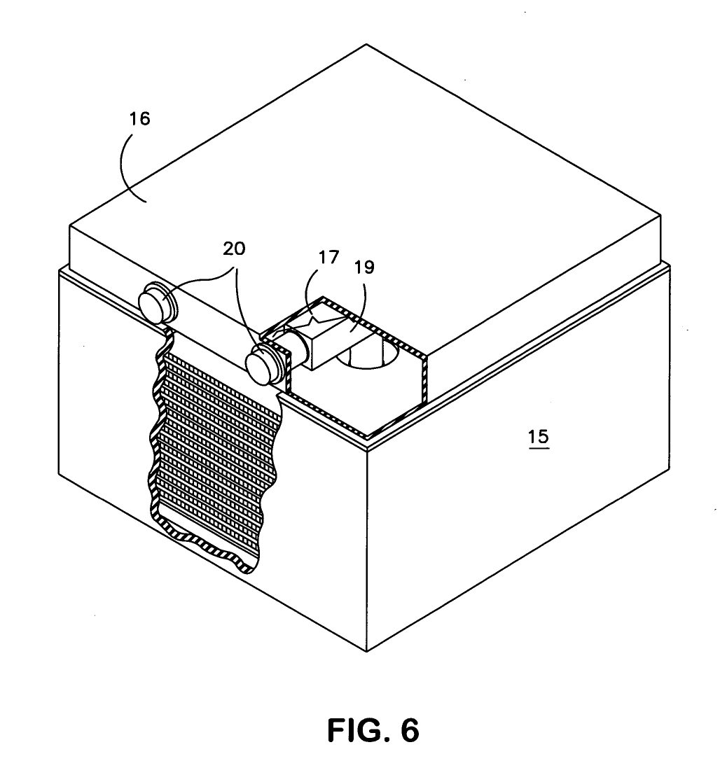

As shown in FIG. 6, the cell can be fitted with an alternative molded plastic cover 16 which can be used to position the cell's terminal posts to the front of the cell assembly. The current collector pole fits into an integral bushing 19 and a terminal post assembly 17, much like that used in monoblock battery designs. Preferably, the lead bushing 19 and the terminal post assembly 17 may be molded into the cover 16, preferably as an integral bushing 19 through which the current collector poles 8 and 9 pass, with terminal posts 20 (possibly fitted with a copper, or other conductive material, insert for improved conductivity) to allow for connection to external circuits. For higher capacity cells, requiring greater current carrying capabilities, multiple terminal posts 20 of the same polarity may be provided. The terminal posts 20 may be located on the top of the cover 16 or, in the envisioned invention as shown in FIG. 6, along one of the sides of the cover 16 to provide ready access for making electrical connections. Because the plate assembly has a uniform footprint (varying for capacity only in height), a single cover 16 (possibly with multiple inserts) could be designed and utilized for a wide variety of batteries.

The cover 16 is preferably heat-welded to the jar 15 or bonded to the jar using any other method commonly used in the manufacture of lead-acid batteries, such as solvent-bonding and epoxy-bonding, to provide a leak tight seal between the jar 15 and the cover 16. The current collector poles 8 and 9 are preferably welded to the bushing 19 inserted into the cover 16 using a variety of techniques including Gas Tungsten Arc Welding (TIG) and/or an inductive heat generation processes. The cover 16 may be fitted with access ports for electrolyte filling and to accommodate placement of a pressure relief vent valve typical for VRLA designs, as desired.

The battery cell is then filled with an appropriate concentration of sulfuric acid electrolyte and given its initial formation charge using processes commonly known in the art.

Welding of the individual plates to the current collector posts 8 and 9 may be accomplished using laser welding techniques, TIG welding techniques, and even resistance welding techniques. Performance of the battery may be enhanced by welding each of the plates 12 and 13 to its respective current collector post 8 and 9 while the plate is positioned over the current collector posts and held under compression by the assembly device, but these steps are not required for the construction of a storage battery.

The normal position of the cell for installation and operation would be with the cell in the vertical orientation and the grid elements disposed in the horizontal orientation. This orientation will keep any free liquid electrolyte away from the jar-to-cover seal and the terminal post seals, thus increasing the reliability of these seals and reducing the possibility for electrolyte leakage. The terminal posts 20 could be positioned in any of four directions conforming to various layout arrangements. In addition, it is possible to install the cell in a horizontal position with the terminal posts located on the upper edge of the front of the cell cover. The configuration of the cell allows for a myriad of configuration possibilities.

4. Conclusion

Advantageous features according to the present invention include:

The battery will have a reduced resistance grid design that will increase active material utilization, increase battery capacity, and improve energy and power density;

The method provides a simplified manufacturing process with a reduced number of standardized components used to build a wide range of battery capacities;

The method provides for a single plate set that can be used for a broad range of battery products;

The battery only requires a single molded jar (cut to the appropriate heights) and a single molded cover (possibly with the capability to provide multiple terminal post inserts);

The battery provides uniform and consistent compression to the microporous fiberglass mat separator over the lifetime of the battery cell;

The battery incorporates various elements to reduce the overall internal resistance of the battery, including low resistance current collector poles (with copper inserts for example), multiple terminal post connectors, short distance current paths between connections and terminal posts, and a low resistance grid design;

The manufacturing processes for the assembly of the disclosed battery are repetitive and conducive to automated assembly and manufacturing techniques.

Thus, what has been described is a unique storage battery and method for producing same that provides low internal resistance, has a simplified manufacturing process with reduced number of components, and is easily modified to various electrical storage capacities to suit a variety of applications.

The individual components shown in outline or designated by blocks in the attached Drawings are all well-known in the battery arts, and their specific construction and operation are not critical to the operation or best mode for carrying out the invention.

While the present invention has been described with respect to what is presently considered to be the preferred embodiments, it is to be understood that the invention is not limited to the disclosed embodiments. To the contrary, the invention is intended to cover various modifications and equivalent arrangements included within the spirit and scope of the appended claims. The scope of the following claims is to be accorded the broadest interpretation so as to encompass all such modifications and equivalent structures and functions.

All U.S. patents and patent applications discussed above are hereby incorporated by reference into the Detailed Description of the Preferred Embodiments.

What is claimed is:

1. A lead-acid battery, comprising:
a first electrode plate comprising (i) a frame, (ii) a plurality of intersecting conducting members forming a grid disposed in the interior of said frame, (iii) first and second collector pole access channels disposed in the interior of said frame, (iv) a coating of a lead-acid battery active material paste; and
a second electrode plate comprising (i) a frame, (ii) a plurality of intersecting conducting members forming a grid disposed in the interior of said frame, (iii) first and second collector pole access channels disposed in the interior of said frame, (iv) a coating of a lead-acid battery active material paste; and
a first current collector pole configured to be installed in the first collector pole access channel of the first electrode plate and the first collector pole access channel of the second electrode plate; and
a second current collector pole configured to be installed in the second collector pole access channel of the first electrode plate and the second collector pole access channel of the second electrode plate.

2. The lead-acid battery according to claim 1, wherein each electrode plate is substantially square.

3. The lead-acid battery according to claim 2, wherein the collector pole access channels in each electrode plate are diagonally arrayed with respect to the grid frame.

4. The lead-acid battery according to claim 3, wherein each collector pole access channel in each electrode plate is disposed substantially one third of the diagonal distance from opposite corners of the grid frame.

5. The lead-acid battery according to claim 1, wherein one collector pole access channel in each electrode plate is configured to interference-fit with the corresponding current collector pole.

6. The lead-acid battery according to claim 5, wherein another collector pole access channel of each electrode plate is larger than the outside diameter of the corresponding current collector pole.

7. The lead-acid battery according to claim 1, wherein each collector pole has a cross section that is selected from a group comprised of circular, hexagonal, and octagonal.

8. The lead-acid battery according to claim 1, wherein each collector pole comprises lead and a copper core.

9. The lead-acid battery according to claim 1, wherein each grid comprises lead.

10. The lead-acid battery according to claim 1, further comprising with a mat separator disposed between the first and second electrode plates.

11. A lead-acid storage battery electrode grid comprising:
a frame;
a plurality of intersecting members forming a grid disposed interiorly of the frame;
at least two disc slugs disposed in the interior of the frame, said slugs configured to be hole-punched to accommodate current collector poles through the punched holes.

12. The electrode grid according to claim 11, wherein the frame is substantially square.

13. The electrode grid according to claim 12, wherein the slugs are diagonally arrayed with respect to the grid frame.

14. The electrode grid according to claim 13, wherein each slug is disposed substantially one third of the diagonal distance from opposite corners of the grid frame.

15. The electrode grid according to claim 11, wherein one slug is configured to be hole-punched to form a collector pole access channel that is configured to interference-fit with the corresponding current collector pole.

16. The electrode grid according to claim 15, wherein another slug is configured to be hole-punched to form a collector pole access channel configured to be larger than the outside diameter of the corresponding current collector pole.

17. The electrode grid according to claim 11, wherein the electrode comprises lead.

18. The lead-acid battery according to claim 11, further comprising two current collector poles, and a punched hole is welded to one of said poles.

19. A lead-acid battery, comprising:
a plurality of electrode plates, each said electrode plate comprising (i)a frame, (ii) a plurality of intersecting conducting members forming a grid disposed interiorly of said frame, (iii) at least two collector pole access channels disposed in the grid interiorly of the frame, and (iv)a coating of a lead-acid battery active material paste; and
two current collector poles each configured to be received in one of said collector pole access channels of each of said electrode plates; and
a plastic jar configured for containing said plurality of electrode plates and at least two current collector poles; and
a plastic cover configured to be sealed on said jar for containment of an electrolyte fluid.

20. The lead-acid battery according to claim 19, wherein each electrode is substantially square.

21. The lead-acid battery according to claim 19, wherein the collector pole access channels of each electrode plate are diagonally arrayed with respect to the grid frame.

22. The lead-acid battery according to claim 21, wherein each collector pole access channel of each electrode plate is disposed one third of the diagonal distance from opposite corners of the grid frame.

23. The lead-acid battery according to claim 19, wherein one collector pole access channel in each electrode plate is configured to interference-fit with the corresponding current collector pole.

24. The lead-acid battery according to claim 23, wherein another collector pole access channel in each electrode plate is larger than the outside diameter of the corresponding current collector pole.

25. The lead-acid battery according to claim 19, wherein each collector pole has a cross section that is selected from a group comprised of circular, hexagonal, or octagonal.

26. The lead-acid battery according to claim 19, wherein each current collector pole comprises lead with a copper core.

27. The lead-acid battery according to claim 19, wherein each electrode comprises lead.

28. The lead-acid battery according to claim 19, further comprising a mat separator disposed between two of said electrode plates.

29. The lead-acid battery according to claim 28, wherein each electrode plate is welded to a respective current collector pole.

30. The lead-acid battery according to claim 19, wherein said cover further comprises (i) terminal leads, and (ii) a bushing configured to electrically connect said current collector poles with said terminal leads.

31. A lead-acid battery, comprising:
a plurality of electrode plates, each electrode plate comprising (i)a frame, (ii) a plurality of intersecting conducting members forming a grid disposed interiorly of said frame, (ii) at least two collector pole access channels disposed interiorly of the frame, and (iv) a coating of a lead-acid battery active material paste; and
two current collector poles respectively configured to be received in one of said collector pole access channels of each of said electrode plates;
a plastic jar configured to contain said plurality of electrodes and at least two current collector poles;
a plastic cover configured to be sealed on said jar for containment of an electrolyte fluid and comprising terminal leads and a bushing configured to electrically connect said current collector poles with said terminal leads; and
an electrolyte fluid contained in said plastic jar.

32. A storage battery electrode plate, comprising:
a frame;
a grid of elements disposed interiorly of the frame; and
a first collector pole access channel disposed interiorly of the frame and orthogonal with respect to the grid of elements; and
a second collector pole access channel disposed interiorly of the frame and orthogonal with respect to the grid of elements.

33. A method for constructing a lead-acid battery comprising the steps of:
providing first and second current collector poles;
providing first and second electrode plates, each electrode plates comprising (i) a frame, (ii) a plurality of intersecting conducting members forming a grid disposed interiorly of the frame, (iii) first and second disc slugs disposed interiorly of the frame, and (iv) a coating of a lead-acid battery active material paste;
hole-punching said first slug of said first electrode plate forming a collector pole access channel configured to interference-fit with said first current collector pole;
hole-punching said second slug of said first electrode to form a collector pole access channel configured to be larger than the outside diameter of said second current collector pole;
installing said first electrode onto the current collector poles and welding said first electrode to said first current collector pole at the interference-fit with said first collector pole access channel;
covering said second electrode plate with a mat separator;
hole-punching said first slug of said second electrode plate and separator to form a collector pole access channel configured to be larger than the outside diameter of said first current collector pole;
hole-punching said second slug of said second electrode plate and separator to form a collector pole access channel configured to interference-fit with said second current collector pole; and
installing said second electrode onto the current collector poles and welding said second electrode to said second current collector pole at the interference-fit with said second collector pole access channel.

34. The method of claim 33, further comprising the step of placing the stack of electrodes and current collector poles inside of a plastic jar and sealing a plastic cover to said plastic jar.

35. The method of claim 33, wherein the even numbered electrodes are covered with a microporous fiberglass mat separator.

36. The method of claim 35, wherein each electrode covered by the microporous fiberglass separator is hole-punched after being covered with the microporous fiberglass mat separator.

37. The method of claim 33, further comprising the steps of:
selecting the number of electrodes in accordance with a predetermined desired battery capacity: and
trimming said plastic jar to a height corresponding to the selected number of electrodes.
